(19) United States
(12) Patent Application Publication
(10) Pub. No.: US 2005/0211789 A1
(43) Pub. Date: Sep. 29, 2005

(54) Glass substrate having oblique two-dimensional barcode

(75) Inventors: Ho-Li Hsieh, Miao-Li (TW); Hung-Wen Yang, Miao-Li (TW); Ching-Lung Wang, Miao-Li (TW); Yu-Ying Chan, Miao-Li (TW); Tseng-Kuei Tseng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/092,230

(22) Filed: Mar. 28, 2005

(30) Foreign Application Priority Data
Mar. 26, 2004 (TW) 93108263

(51) Int. Cl. G06K 19/06

(52) U.S. Cl. 235/494

(57) ABSTRACT

A glass substrate includes a two-dimensional barcode, which is provided on a peripheral region of a major surface of the glass substrate. A side of the two-dimensional barcode is oblique to a nearest side of the glass substrate. The two-dimensional barcode includes a reference line, and is for recording identification information of the glass substrate. If the two-dimensional barcode sustains partial damage at the nearest side of the glass substrate, there is a reasonable likelihood that only part of the side of the two-dimensional barcode will sustain damage. In such case, the risk of damage occurring to the reference line of the two-dimensional barcode is minimized. If the reference line remains intact, then the two-dimensional barcode can still be properly read.

### BACKGROUND OF THE INVENTION

1. Field of the Invention

The present invention relates to glass substrates such as those employed in making liquid crystal displays (LCDs), and particularly to a glass substrate having identification information recorded thereon.

2. General Background

Generally, during the process of fabricating LCDs, barcodes are applied to fabricated thin film transistor (TFT) substrates and color filter substrates in order to record identification information of these glass substrates.

As shown in FIG. 5, a one-dimensional barcode can be used to record information of a glass substrate. The one-dimensional barcode uses a series of parallel lines to record the identification information of the glass substrate. The one-dimensional barcode can be read in one direction only (usually in the transverse direction). Therefore the data capacity of the one-dimensional barcode is low. The one-dimensional barcode has a verifying function to prevent misreading. Nevertheless, if the barcode is damaged, it cannot be read by a code reading device.

Recently, a two-dimensional barcode has been developed in an effort to overcome the above problems. Referring to FIG. 6, a typical two-dimensional barcode uses a type of matrix of one-dimensional barcodes to recode the identification information. The two-dimensional barcode can record the information in both a horizontal direction and a vertical direction. Further, the two-dimensional barcode includes several sub-areas, therefore its data capacity is larger than that of a one-dimensional barcode.

Thus the two-dimensional barcode can overcome the above-described problems of the one-dimensional barcode. The two-dimensional barcode not only can prevent misreading, but also can provide the correct information by way of its sub areas. Further, the matrix type two-dimensional barcode has four sub-areas to repeatedly recode information. As shown in FIG. 7, if one of the sub-areas is damaged and the damaged area is small, the code reading device can still identify the reference line of the barcode. In such case, the code reading device can utilize the relevant coding rule to recode the information. Therefore the damaged area does not affect the proper functioning of the two-dimensional barcode.

As shown in FIGS. 8-10, if more than two sub-areas are damaged, then the code reading device cannot find the reference line of the barcode, and therefore cannot properly read the two-dimensional barcode.

As shown in FIG. 11, a two-dimensional barcode 72 is usually formed on a peripheral region of a major surface of a glass substrate 7, with a side of the two-dimensional barcode 72 being parallel to a nearest side of the substrate 7. Referring also to FIG. 12, in cleaning or exposure steps of the fabrication process, the glass substrate 7 is liable to sustain damage in an area 74, due to instability in the processes or to other causes. The damaged area 74 may result in damage occurring to the two-dimensional barcode 72. Even if the damaged area 74 is small, because the side of the two-dimensional barcode 72 is parallel to the nearest side of the substrate 7, the reference line of the two-dimensional barcode 72 is likely to be damaged. If this happens, the information of the two-dimensional barcode 72 cannot be properly read.

In order to overcome the above-described problems, what is needed is a new glass substrate having a two-dimensional barcode, wherein the risk of damage occurring to the reference line of the barcode is minimized.

### SUMMARY

In a preferred embodiment, a glass substrate includes a two-dimensional barcode, which is provided on a peripheral region of a major surface of the glass substrate. A side of the two-dimensional barcode is oblique to a nearest side of the glass substrate. The two-dimensional barcode includes a reference line, and is for recording identification information of the glass substrate.

It is of advantage that the two-dimensional barcode is oblique to the nearest side of the glass substrate. If the two-dimensional barcode sustains partial damage at the nearest side of the glass substrate, there is a reasonable likelihood that only part of the side of the two-dimensional barcode will sustain damage. In such case, the risk of damage occurring to the reference line of the two-dimensional barcode is minimized. If the reference line remains intact, then the two-dimensional barcode can still be properly read.

Other advantages and novel features will become more apparent from the following detailed description when taken in conjunction with the accompanying drawings, in which:

### BRIEF DESCRIPTION OF THE DRAWINGS

FIG. 1 is a schematic, plan view of a glass substrate in accordance with a first embodiment of the present invention;

FIG. 2 is an enlarged view of a matrix type two-dimensional barcode of the glass substrate of FIG. 1;

FIG. 3 is a schematic, plan view of a glass substrate in accordance with a second embodiment of the present invention;

FIG. 4 is an enlarged view of a matrix type two-dimensional barcode of the glass substrate of FIG. 3;

FIG. 5 is a plan view of a conventional one-dimensional barcode;

FIG. 6 is a plan view of a conventional two-dimensional barcode;

FIGS. 7-10 are each similar to FIG. 6, but showing different scenarios of damage occurring to different areas of the two-dimensional barcode;

FIG. 11 is a schematic, plan view of a two-dimensional barcode formed on a glass substrate according to conventional art; and

FIG. 12 is an enlarged view of the two-dimensional barcode of FIG. 11.

### DETAILED DESCRIPTION OF PREFERRED EMBODIMENTS

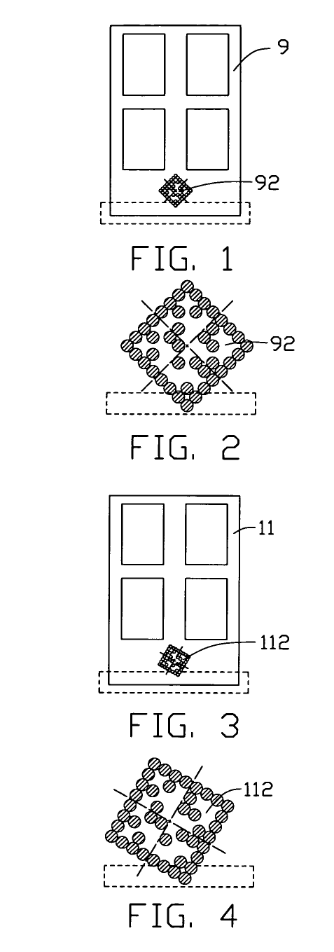

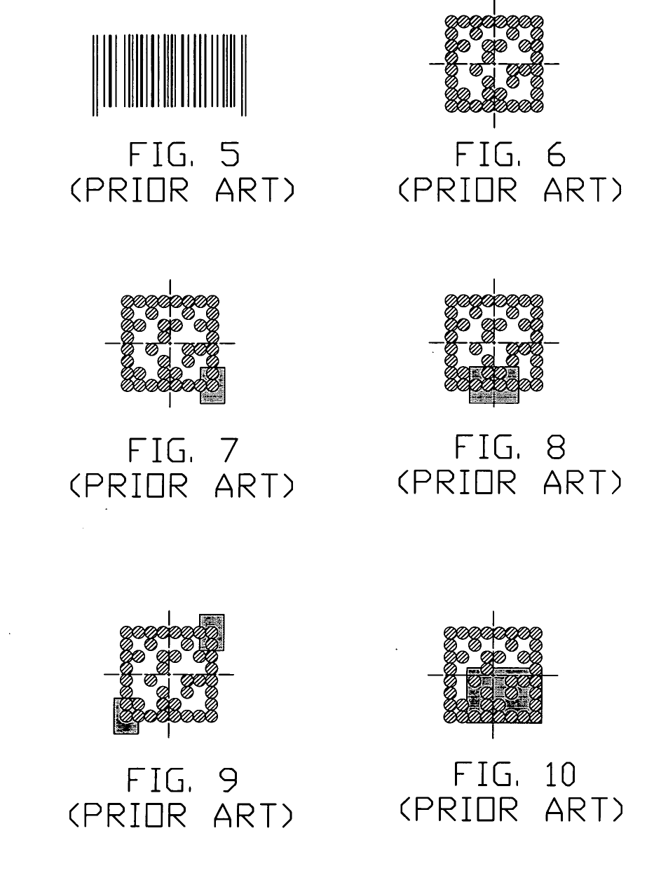

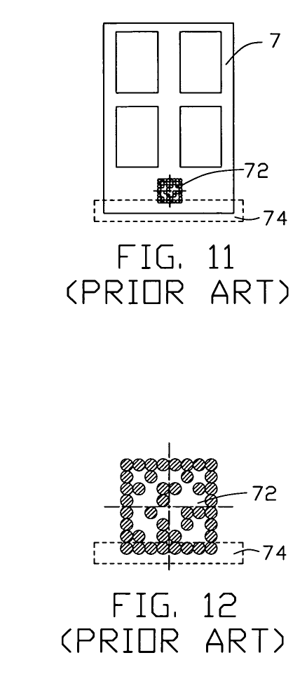

FIGS. 1-2 show a glass substrate 9 in accordance with a first embodiment of the invention. The glass substrate 9 includes a matrix type two-dimensional barcode 92, which is formed on a peripheral region of a major surface of the glass substrate 9. An angle between a nearest side of the glass substrate 9 and either of two adjacent sides of the two-dimensional barcode 92 is about 45°. The two-dimensional barcode 92 has four sub-areas for recording identification information of the glass substrate 9. The four sub-areas are defined by a cross-shaped reference line.

The two adjacent sides of the two-dimensional barcode 92 are oblique to the nearest side of the glass substrate 9, and the reference line is also oblique to the nearest side of the glass substrate 9. Therefore if the two-dimensional barcode 92 is partially damaged at a portion thereof at the nearest side of the glass substrate 9 (as indicated by a dashed line in FIGS. 1-2), there is a reasonable likelihood that only one sub-area of the two-dimensional barcode 92 will be damaged. If so, a code reading device can still identify the reference line of the barcode, and can still precisely read the identification information of the two-dimensional barcode 92.

FIGS. 3-4 show a glass substrate 11 in accordance with a second embodiment of the invention. The glass substrate 11 includes a matrix type two-dimensional barcode, which is formed on a peripheral region of a major surface of the glass substrate 11. An angle between a nearest side of the glass substrate 11 and one side of the two-dimensional barcode 112 is about 30°. An angle between the nearest side of the glass substrate 11 and an adjacent side of the two-dimensional barcode 112 is 60°. The two-dimensional barcode 112 has four sub-areas for recording identification information of the glass substrate 11. The four sub-areas are defined by a cross-shaped reference line. In similar fashion to glass substrate 9, the orientation of the two-dimensional barcode 112 helps limit the risk of damage to damage to only one sub-area.

In other embodiments, an angle between the nearest side of the glass substrate and either of two adjacent sides of the two-dimensional barcode can be any oblique angle other than 45°, 30° or 60°. The two-dimensional barcode can be of a type other than a matrix type. That is, the two-dimensional barcode can be constituted according to another kind of coding rule.

The glass substrate can be used as or used for a TFT substrate, a color filter substrate, or another kind of display apparatus substrate.

It is to be understood that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A glass substrate, comprising:
a two-dimensional barcode for recording identification information of the glass substrate, the two-dimensional barcode being provided on a peripheral region of a major surface of the glass substrate, with a side of the two-dimensional barcode being oblique to a nearest side of the glass substrate.

2. The glass substrate as claimed in claim 1, wherein the two-dimensional barcode is a matrix type two-dimensional barcode.

3. The glass substrate as claimed in claim 1, wherein an angle between the side of the two-dimensional barcode and the nearest side of the glass substrate is approximately 45°.

4. The glass substrate as claimed in claim 1, wherein an angle between the side of the two-dimensional barcode and the nearest side of the glass substrate is approximately 30°.

5. The glass substrate as claimed in claim 1, wherein an angle between the side of the two-dimensional barcode and the nearest side of the glass substrate is approximately 60°.

6. The glass substrate as claimed in claim 1, wherein the glass substrate is a thin film transistor substrate for a liquid crystal display.

7. The glass substrate as claimed in claim 1, wherein the glass substrate is a color filter substrate for a liquid crystal display.

8. A glass substrate, comprising:
a two-dimensional barcode arranged in matrix for recording identification information of the glass substrate, the two-dimensional barcode being provided on a peripheral region of a major surface of the glass substrate, wherein
a corner of said matrix is closer to said peripheral region than any other corners.

9. A method of identifying a glass substrate, comprising steps of:
providing a glass substrate;
applying a polygon like barcode upon a peripheral region of said glass substrate; wherein
a corner of said polygon like bard code is closer to said peripheral region than any other corners.
